(19) United States
(12) Patent Application Publication
(10) Pub. No.: US 2026/0298687 A1
(43) Pub. Date: Oct. 1, 2026

(54) Hanging Tank Scale

(71) Applicant: Weber-Stephen Products LLC, Palatine, IL (US)

(72) Inventors: Nicholas Beyrer, San Francisco, CA (US); Gabriel Risk, San Francisco, CA (US); Heston Liebowitz, Colorado Springs, CO (US); Joseph Ciway, Chicago, IL (US)

(21) Appl. No.: 19/634,226

(22) Filed: Mar. 31, 2026

Related U.S. Application Data
(60) Provisional application No. 63/781,466, filed on Apr. 1, 2025.

(51) Int. Cl. G01F 23/20; G01G 19/14; G01G 19/52; G01G 23/37

(52) U.S. Cl. CPC G01F 23/20; G01G 19/14; G01G 19/52; G01G 23/3707; G01G 23/3728

(57) ABSTRACT

The present disclosure describes scales, and other devices, configured to measure a weight or mass of a tank that is suspended (e.g., hung) from a support mechanism. A sensor may be configured to measure a weight of the tank. Once the weight of the tank is determined, a processor may be configured to determine a volume of a liquid contained in the tank based on the determined weight. The hanging tank scale described herein may further comprise a transceiver configured to transmit the volume of the liquid to a computing device, such as a server or a mobile device. The hanging tank scale described herein may comprise a first display configured to display the volume of the liquid and/or a second display configured to display a power of the batteries of the hanging tank scale.

### CROSS-REFERENCE TO RELATED APPLICATIONS

This application claims priority to U.S. Provisional Application No. 63/781,466, filed on April 1, 2025 and entitled “Hanging Tank Scale,” the entirety of which is incorporated herein by reference for all purposes.

### TECHNICAL FIELD

Aspects of the disclosure generally relate to scales and other devices configured to measure weight or mass and, in particular, the weight or mass of hanging objects.

### BACKGROUND OF THE INVENTION

Scales and other devices configured to measure weight or mass of hanging objects typically rely on springs. However, the springs may fatigue over time, causing inaccurate readings. Moreover, the springs can be adversely affected by temperatures leading to inaccurate measurements. Accordingly, there is a need for an improved device and methods for measuring the weight and/or mass of hanging objects.

### SUMMARY OF THE INVENTION

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Aspects of the disclosure generally relate to scales and other devices configured to measure weight or mass. In particular, the present disclosure describes scales and other devices configured to measure the weight, or mass, of a tank that is suspended (e.g., hung) from a support mechanism, such as an arm. The scale of the present disclosure may use one or more sensors to determine a weight of the tank. Based on the weight of the tank, a processor may be configured to determine a volume of the tank. The volume of the tank may be displayed, for example, on a display located on an exterior surface of the scale. Additionally or alternatively, the scale may comprise a transceiver configured to transmit (e.g., send) the weight and/or the volume of the tank to a computing device, such as a server or a computing device (e.g., smart phone, tablet, etc.). The weight and/or volume of the tank may be displayed via an application executing on the computing device.

### BRIEF DESCRIPTION OF DRAWINGS

The present disclosure is described by way of example and not limited in the accompanying figures in which like reference numerals indicate similar elements and in which:

FIGS. 1A-1B show an example of a hanging tank scale incorporated in a cooking appliance in accordance with one or more aspects of the disclosure;

FIG. 2 shows an example of a hanging tank scale in accordance with one or more aspects of the disclosure;

FIG. 3 shows an example of a hanging tank scale in accordance with one or more aspects of the disclosure;

FIG. 4 shows an example of a hanging tank scale in accordance with one or more aspects of the disclosure;

FIGS. 5A-5B show an example of a support mechanism in accordance with one or more aspects of the disclosure;

FIG. 6 shows an example of the computing elements that may be implemented as part of tank scale in accordance with one or more aspects of the disclosure;

FIG. 7 shows an example of an environment in which a hanging tank scale may deployed in accordance with one or more aspects of the disclosure;

FIG. 8 shows an example of an interface for displaying a volume of a tank in accordance with one or more aspects of the disclosure; and

FIG. 9 shows an example of an interface on a wearable device in accordance with one or more aspects of the disclosure.

### DETAILED DESCRIPTION OF THE INVENTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to scales and other devices configured to measure weight or mass. In particular, the present disclosure describes a hanging tank scale. The hanging tank scale is configured to measure the weight and/or mass of a tank that is suspended (e.g., hung) from a support mechanism. A sensor may be configured to measure a weight of the tank. As will be described in greater detail below, the sensor may be a time-of-flight sensor, a load cell, a hall effect sensor, a potentiometer, or any equivalent thereof. The sensor may be configured to determine the weight of the tank, for example, based on a distance travelled by the support mechanism. Additionally or alternatively, the sensor may be configured to determine the weight of the tank, for example, based on a voltage detected by the potentiometer. Once the weight of the tank is determined, a processor may be configured to determine a volume of a liquid (e.g., fuel) contained in the tank based on the determined weight. The hanging tank scale described herein may further comprise a transceiver configured to transmit the volume of the liquid to a computing device, such as a server or a mobile device. The hanging tank scale described herein may comprise a first display configured to display the volume of the liquid and/or a second display configured to display a power of the batteries of the hanging tank scale.

According to some examples, the hanging tank scale of the present disclosure may comprise a housing. The housing may comprise a box with four sides, a top, and a bottom. The housing may be configured to enclose the electrical components described above. Preferably, the support mechanism extends outward from the housing to receive the tank. The first display and/or the second display may be on an exterior surface of the housing.

In further examples, the hanging tank scale of the present disclosure may be part of a cooking apparatus, such as a grill, a fryer, or a smoker. The hanging tank scale may send (e.g., transmit) the volume of the tank to a computing device. The computing device may display the volume of the tank. Additionally or alternatively, the computing device may be configured to determine an amount of available cooking time, for example, based on the volume of the tank. The computing device may also use the type of cooking apparatus in the determination of the amount of available cooking time. The volume of the tank and/or the amount of available cooking time may be displayed, for example, via a mobile application executing on a mobile device or via a website.

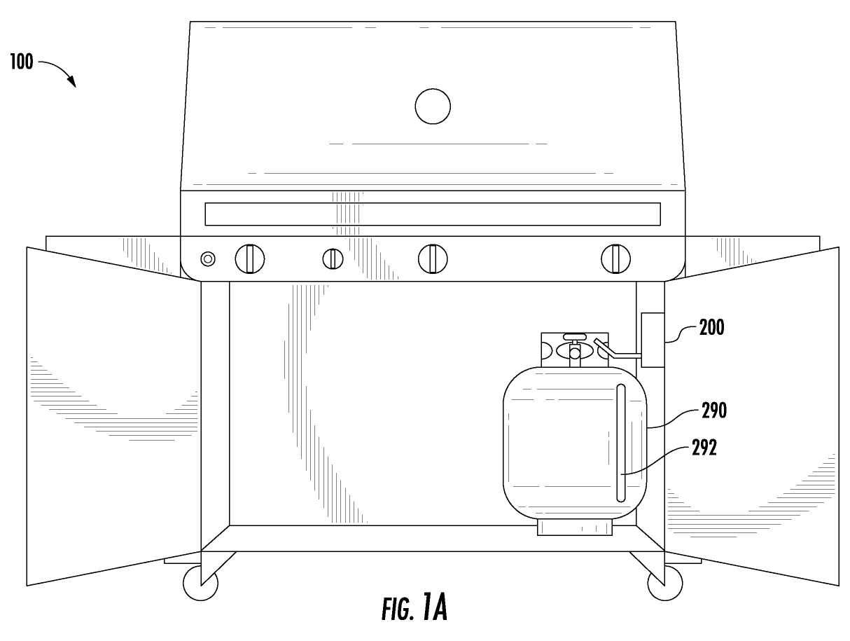

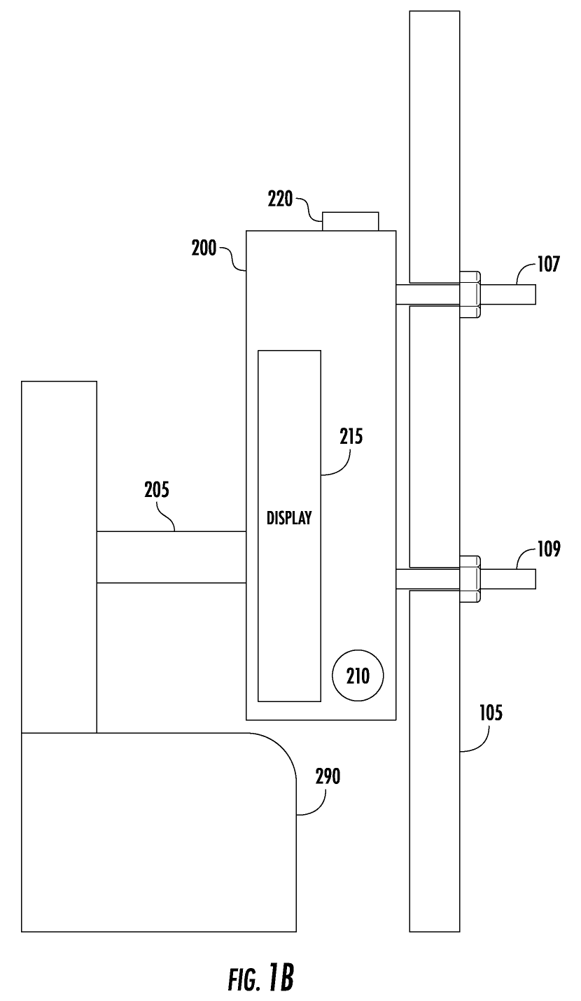

FIGS. 1A-1B show an example of a tank scale 200 incorporated in a cooking appliance 100 in accordance with one or more aspects of the disclosure. As shown in FIG. 1A, cooking appliance 100 may be a grill. It will be appreciated that cooking appliance 100 may be any suitable cooking appliance, such as a smoker, a pizza oven, a griddle, and the like. As will be discussed in greater detail below, tank scale 200 may comprise a support mechanism (e.g., an arm) configured to receive fuel tank 290. In particular, fuel tank 290 may comprise a propane tank. As shown in FIG. 1A, fuel tank 290 may be located in a cabinet, or storage area, below a cooking surface. Although shown below a cooking surface, it will be appreciated that fuel tank 290 may be located in any suitable location. Fuel tank 290 may comprise pad 292. Pad 292 may be configured to display a volume of fuel in fuel tank 290. Pad 292 may detect a temperature on the surface of fuel tank 290. A difference in temperature may be displayed on pad 292 and be indicative of the volume of fuel contained in fuel tank 290.

FIG. 1B shows a more detailed view of tank scale 200. As shown in FIG. 1B, tank scale 200 comprises support mechanism 205, sensor 210, display 215, and button 220. Additionally, FIG. 1B illustrates tank scale 200 in relation to fuel tank 290 and wall 105 of cooking appliance 100. In this regard, tank scale 200 may be fastened to wall 105 using at least a first fastener 107 and a second fastener 109. First fastener 107 and second fastener 109 may be any suitable fastener, including screws, nuts and bolts, rivets, and the like. Although only two fasteners are shown in FIG. 1B, it will be appreciated that more, or fewer, fasteners may be used to secure tank scale 200 to wall 105. Furthermore, it will be appreciated that wall 105 may be a glide, similar to a drawer glide. The glide may allow tank scale 200 to slide in and out of the cabinet shown in FIG. 1A. In instances where a glide is used, the movement of the glide (e.g., sliding in, sliding out, etc.) may signal a tare function. The tare function may be used to determine the empty weight of the tank.

Support mechanism 205 may be configured to receive fuel tank 290. Preferably, support mechanism 205 is an arm configured to receive fuel tank 290; however, any suitable protrusion capable of receiving fuel tank 290 may be used. In some examples, support mechanism 205 may comprise a hinge, or any other suitable mechanism, that allows support mechanism 205 to rotate (e.g., swing) approximately 90-degrees. In this regard, support mechanism 205 may rotate (e.g., swing) outside of cabinet to allow fuel tank 290 to be installed more easily. Support mechanism 205 may be made from any material with a yield strength of approximately 40 kilograms (kg), or 90 pounds (lbs). Preferably, support mechanism 205 is made from aluminum, steel, composite, carbon fiber, plastic, glass, polymer, or any combination thereof. Support mechanism 205 may comprise a rust-resistant coating.

Sensor 210 may be configured to detect light. In particular, sensor 210 may be configured to detect ambient light at, or above, a threshold level. In response to a threshold being satisfied, sensor 210 may cause tank scale 200 to display information, for example, via display 215. According to some examples, display 215 may display a battery level and/or a fuel level of fuel tank 290. Sensor 210 may be a photodiode, a photodetector, or a photoreceptor configured to detect light, for example, when cabinet doors of cooking appliance 100 are opened.

Display 215 may be any suitable display configured to display information. Display 215 may comprise a liquid crystal display (LCD) display technology, one or more light emitting diodes (LEDs), ePaper technology (e.g., e-ink), vacuum fluorescent display technology, and/or the like. According to some examples, display 215 may comprise a series of LEDs designed to show a volume of fuel contained in fuel tank 290. Additionally or alternatively, display 215 may be configured to show a battery level of tank scale 200.

Button 220 may be configured to activate display 215. Button 220 may be any suitable button for activating display 215, including, for example, a push button, a toggle, etc. While button 220 is shown on the top of tank scale 200, it will be appreciated that button 220 may be located on any exterior surface of tank scale 200. Alternatively, button 220 may be omitted from tank scale 200. As noted above, display 215 may be activated in response to a threshold amount of light being detected. According to some examples, both button 220 and sensor 210 may be omitted. As will be discussed in greater detail below, an accelerometer may be built-in to tank scale 200. The accelerometer may be configured to activate display 215, for example, in response to detecting a user input, such as a tapping on the housing of tank scale 200.

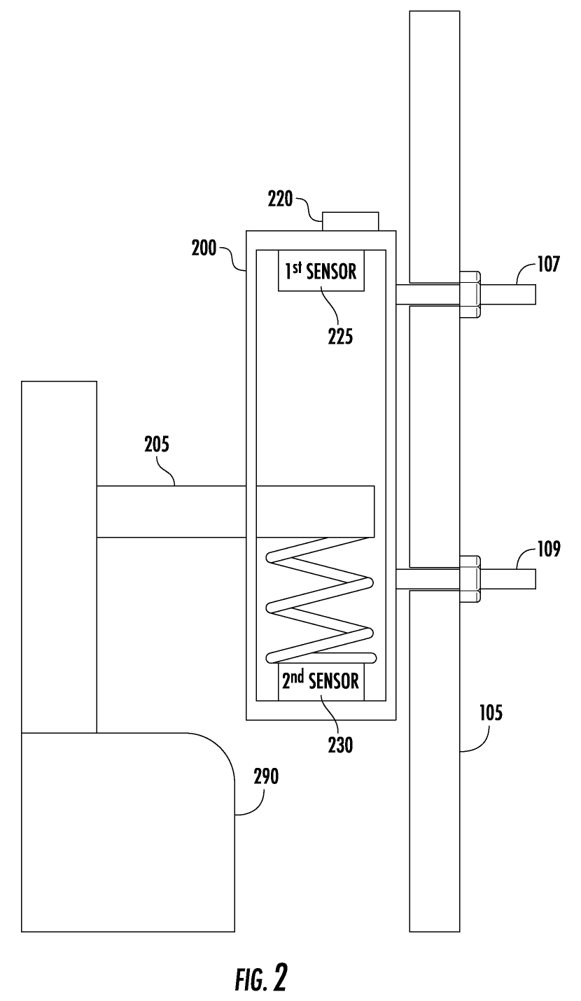

A volume of the fuel contained in the fuel tank may be determined based on the weight of the fuel tank. The weight of the fuel tank may be determined using a plurality of techniques. FIG. 2 shows an example of tank scale 200 with one or more sensors configured to determine a weight of fuel tank 290 in accordance with one or more aspects of the disclosure.

As shown in FIG. 2, tank scale 200 may comprise a first sensor 225 and a second sensor 230. First sensor 225 may be any suitable sensor capable of measuring, calculating, and/or determining a distance travelled by support mechanism 205. The distance travelled by support mechanism 205 may be indicative of a weight of fuel tank 290. For example, a first (e.g., longer) distance may be indicative of a full fuel tank 290, while a second (e.g., shorter) distance may be indicative of a low, or empty, fuel tank 290. Preferably, first sensor 225 is a time-of-flight sensor; however, any suitable sensor capable of measuring, calculating, and/or determining a distance travelled by support mechanism 205 may be used. For example, an indictive position sensor may be used. First sensor 225 may comprise a transmitter (e.g., a time-of-flight transmitter) and a receiver (e.g., a time-of-flight receiver). In operation, the transmitter may be a diode configured to emit (e.g. transmit, send) light (e.g., a laser) at a rear surface of support mechanism 205. The receiver may be a photodetector or a photoreceptor configured to receive the light (e.g., laser beam) reflected off from the surface of support mechanism 205. First sensor 225 may be configured to determine the distance travelled by support mechanism 205, for example, using a roundtrip time from when the light (e.g., laser) was transmitted by time-of-flight transmitter until the reflected light (e.g., laser) was received by the time-of-flight receiver. Based on the distance measured, calculated, and/or determined by first sensor 225, tank scale 200 (e.g., a processor included in tank scale 200) may be configured to determine a volume of fuel in fuel tank 290.

Second sensor 230 may be any suitable sensor capable of measuring, calculating, and/or determining a weight of fuel tank 290. As shown in FIG. 2, a spring may be located between support mechanism 205 and second sensor 230. Second sensor 230 may be a load cell, a hall effect sensor, or any other suitable sensor capable of measuring, calculating, and/or determining a weight of fuel tank 290. Based on the distance measured, calculated, and/or determined by first sensor 225, tank scale 200 (e.g., a processor included in tank scale 200) may be configured to determine a volume of fuel in fuel tank 290.

According to some examples, first sensor 225 may be configured to calibrate second sensor 230. In this regard, a shortest distance measured by first sensor 225 may be indicative of a low, or empty, fuel tank 290. Accordingly, a first weight of fuel tank 290, measured by second sensor 230, may be associated with the shortest distance measured by first sensor 225. The first weight may be stored in a memory of tank scale 200. The first weight may indicate a weight of fuel tank 290. Similarly, a longest distance measured by first sensor 225 may indicate that fuel tank 290 is full. A second weight of fuel tank 290, measured by second sensor 230, may be associated with the longest distance measured by first sensor 225. The second weight may be stored in a memory of tank scale 200. By storing the first and second weights, tank scale 290 may determine when fuel tank 290 is full, when fuel tank 290 is empty, and various states in between.

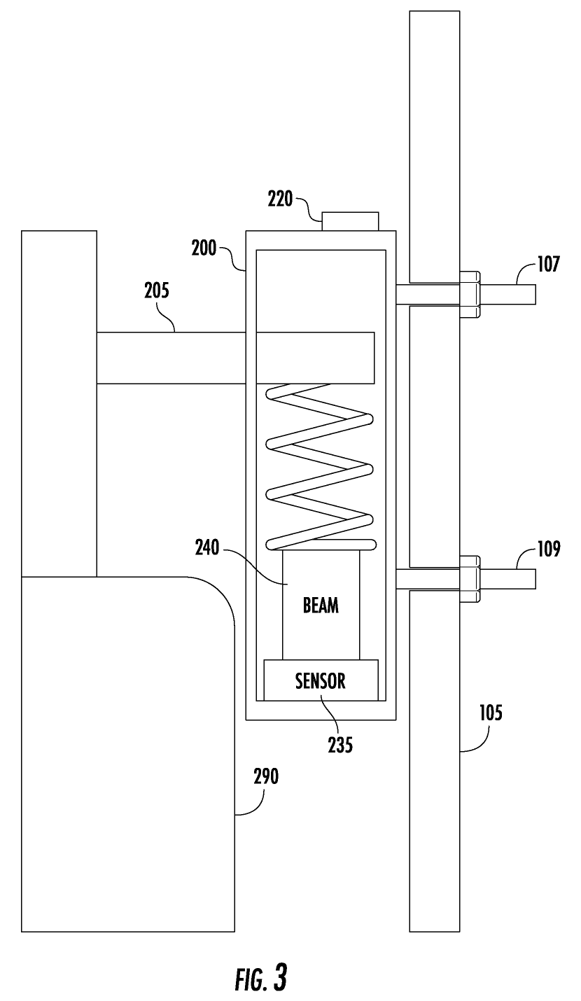

FIG. 3 shows another example of tank scale 200 with one or more sensors configured to determine a weight of fuel tank 290 in accordance with one or more aspects of the disclosure. As shown in FIG. 3, tank scale 200 includes a sensor 235. Similar to second sensor 230, sensor 235 may be configured to measure, calculate, and/or determine a weight of fuel tank 290. Sensor 235 may be configured to detect (e.g., determine) a downward force exerted by support mechanism 205. As shown in FIG. 3B, the downward force may be exerted via a spring and beam 240. Beam 240 may be configured to distribute load across sensor 235 evenly. Additionally or alternatively, beam 240 may protect sensor 235 from damage, for example, when fuel tank 290 is placed on support mechanism 205. Beam 240 may be constructed from aluminum, steel, composite, carbon fiber, plastic, glass, polymer, or any combination thereof.

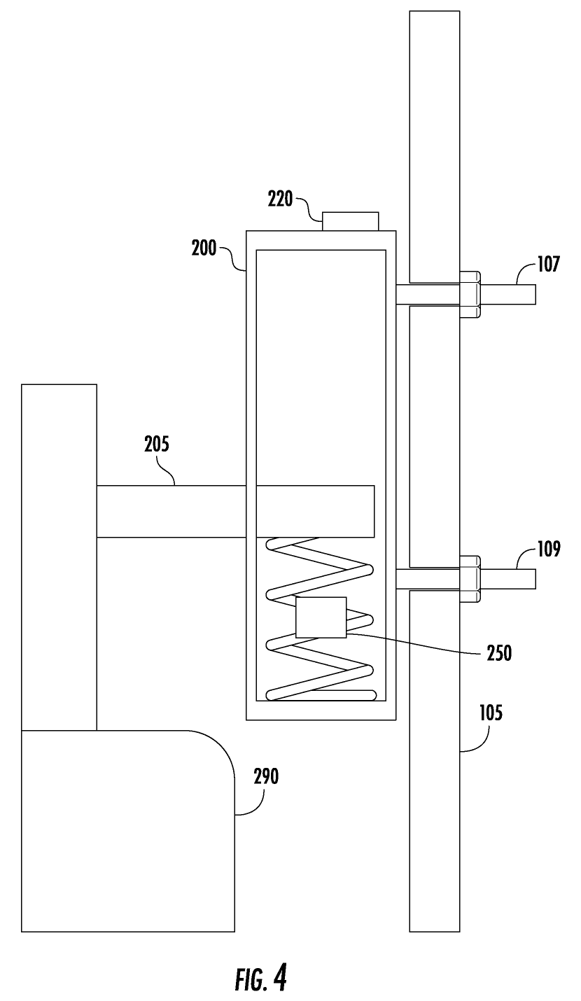

FIG. 4 shows yet another example of tank scale 200 with one or more sensors configured to determine a weight of fuel tank 290 in accordance with one or more aspects of the disclosure. Tank scale 200, as shown in FIG. 4, includes potentiometer 250. In this regard, a small voltage may pass through the spring shown in FIG. 4. As the spring is compressed, the voltage may change. Potentiometer 250 may detect the change in voltage. Based on the change in voltage, tank scale 200 (e.g., a processor associated with tank scale 200) may be able to calculate and/or determine a weight of fuel tank 290. Tank scale 200 may be able to determine a volume of fuel in fuel tank 290, for example, based on the calculated and/or determined weight.

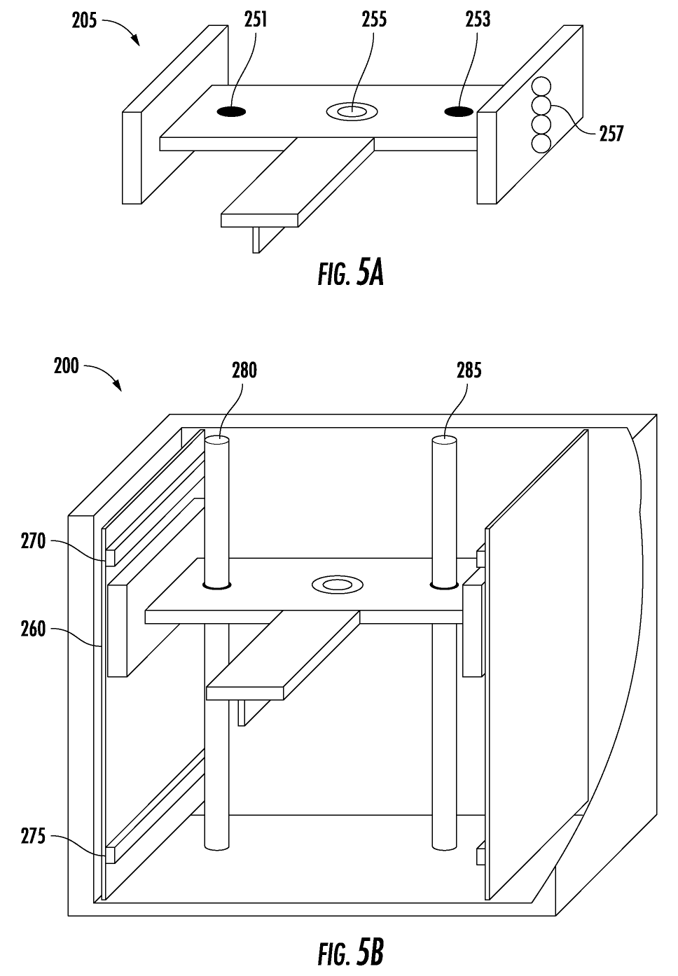

In order to accommodate the sensors and measurement techniques described above, the support mechanism may be modified and/or reinforced. FIGS. 5A-5B show an example of a support mechanism in accordance with one or more aspects of the disclosure.

FIG. 5A shows an example of support mechanism 205. As illustrated, support mechanism 205 may include a first guide hole 251, a second guide hole 253, a target area 255, and/or ball bearings 257. Target area 255 may comprise a reflective material. The reflective material may help reflect light emitted by a time-of-flight sensor, as discussed above. It will be appreciated that target area 255 may be omitted in examples where a time-of-flight sensor is not used. Additionally support mechanism 205 may comprise an I-beam bar configured to receive tank 290. The I-beam bar may increase the yield strength of support mechanism 205.

FIG. 5B shows additional structure of tank scale 200 to accommodate support mechanism 205. Tank scale 200 may include a first channel 260, a second channel 265, an upper stop 270, a lower stop 275, a first guidepost 280, and/or a second guidepost 285. First channel 260 and second channel 265 may be any suitable channel for receiving support mechanism 205. In particular, first channel 260 and second channel 265 may be C-channels. Additionally or alternatively, first channel 260 and second channel 265 may be similar to draw slides. In this regard, ball bearings 257 may engage first channel 260 and second channel 265 to ensure that support mechanism can travel within first channel 260 and second channel 265. Upper stop 270 and lower stop 275 may be configured to stop support mechanism 205. That is, upper stop 270 and lower stop 275 may be the upper and lower limits for support mechanism 205. In this regard, upper stop 270 and lower stop 275 may protect other components, such as the sensors described above. First guide hole 251 and second guide hole 253 may be configured to receive first guidepost 280 and second guidepost 285, respectively. First guidepost 280 and second guidepost 285 may ensure that support mechanism 205 remains centrally located in the housing such that the sensors can measure, calculate, and/or determine the weight of tank 290.

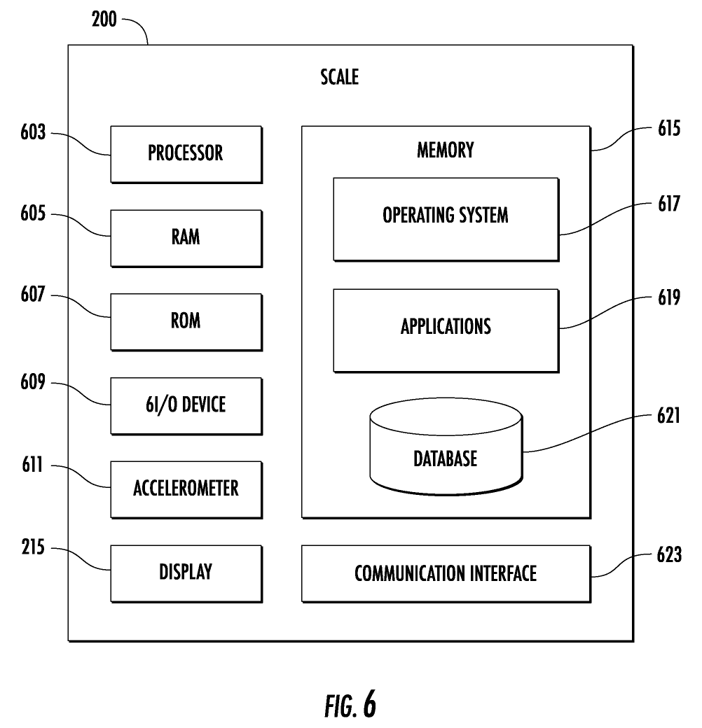

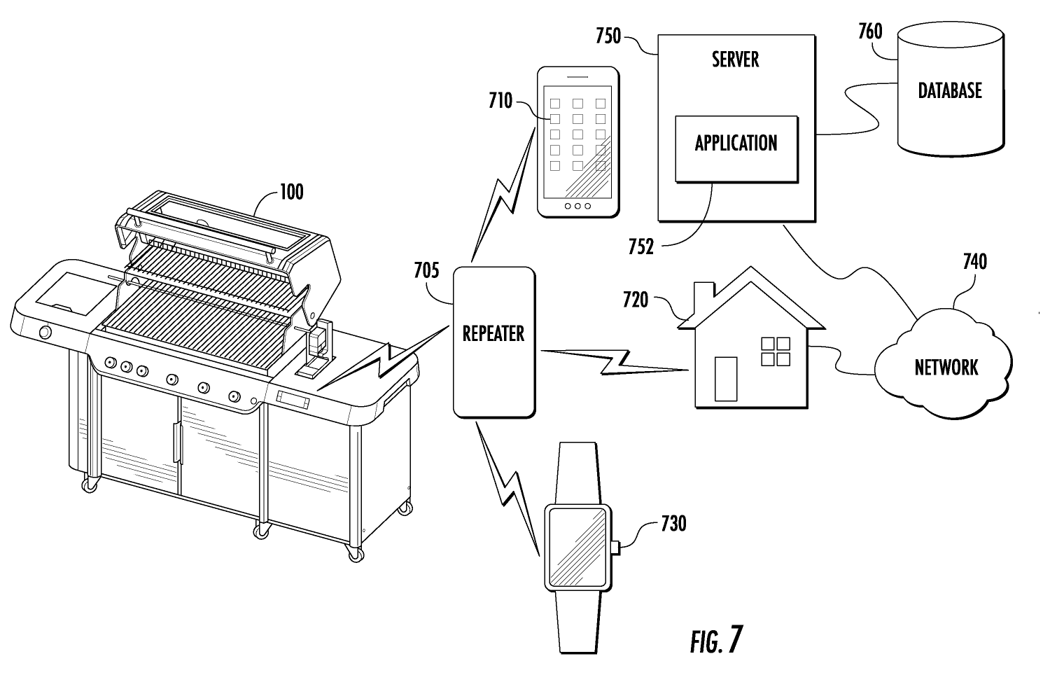

Tank scale 200 may be implemented, in whole or in part, using one or more computing devices. FIG. 6 shows an example of the computing elements that may be implemented as part of scale 200. The computing device 200 may comprise a processor 603 for controlling overall operation of the scale 200 and its associated components, including RAM 605, ROM 607, input/output device 609, accelerometer 611, display 215, memory 615, and/or communication interface 623. A bus (not shown) may interconnect processor(s) 603, RAM 605, ROM 607, memory 615, I/O device 609, accelerometer 611, display 215, memory 615, and/or communication interface 623.

Input/output (I/O) device 609 may comprise an input device, such as a serial port, a USB port, or the like. Software may be stored within memory 615 to provide instructions to processor 603 allowing tank scale 200 to perform various actions. For example, memory 615 may store software used by the tank scale 200, such as an operating system 617, application programs 619, and/or an associated internal database 621. The various hardware memory units in memory 615 may comprise volatile and nonvolatile, removable and non-removable media implemented in any method or technology for storage of information such as computer-readable instructions, data structures, program modules, or other data. Memory 615 may comprise one or more physical persistent memory devices and/or one or more non-persistent memory devices. Memory 615 may comprise random access memory (RAM) 605, read only memory (ROM) 607, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 603.

Accelerometer 611 may be a sensor configured to measure forces exerted on tank scale 200. That is, accelerometer 611 may be configured to detect a user input, such as a tapping on the housing of tank scale 200. Accelerometer 211 may be an electromechanical device.

Display 215 may be any suitable display configured to display information. Display 215 may comprise LCD display technology, one or more LEDs, ePaper technology (e.g., e-ink), vacuum fluorescent display technology, and/or the like. Display 215 may comprise a series of LEDs designed to show a volume of fuel contained in fuel tank 290. Additionally or alternatively, display 215 may be configured to show a battery level of tank scale 200.

Communication interface 623 may comprise one or more antennas, transceivers, digital signal processors, and/or additional circuitry and software, protocol stack, and/or network stack for communicating via any network, wired or wireless, using any protocol as described herein. Communication interface 623 may be configured to send and/or receive electronic communications using a short-range wireless communication protocol, such as Bluetooth, Zigbee, Z-Wave, ANT, LoRa, or any equivalent thereof. Additionally or alternatively, communication interface 623 may be configured to send and/or receive electronic communications and/or signals using wireless communication protocols, such as IEEE 802.11, WiFi, GSM, CDMA, and the like.

Processor 603 may comprise a single central processing unit (CPU), which may be a single-core or multi-core processor, or may comprise multiple CPUs. Processor(s) 603 and associated components may allow the tank scale 200 to execute a series of computer-readable instructions (e.g., instructions stored in RAM 605, ROM 607, memory 615, and/or other memory) to perform some or all of the processes described herein. Although not shown in FIG. 6, various elements within memory 615 or other components in tank scale 200, may comprise one or more caches, for example, CPU caches used by the processor 603, page caches used by the operating system 617, disk caches of a hard drive, and/or database caches used to cache content from database 621. A CPU cache may be used by one or more processors 603 to reduce memory latency and access time. Processor 603 may retrieve data from or write data to the CPU cache rather than reading/writing to memory 615, which may improve the speed of these operations. In some examples, a database cache may be created in which certain data from database 621 is cached in a separate smaller database in a memory separate from the database, such as in RAM 605 or on a separate computing device. These types of caches and others may provide potential advantages in certain implementations of devices, systems, and methods described herein, such as faster response times and less dependence on network conditions when transmitting and receiving data.

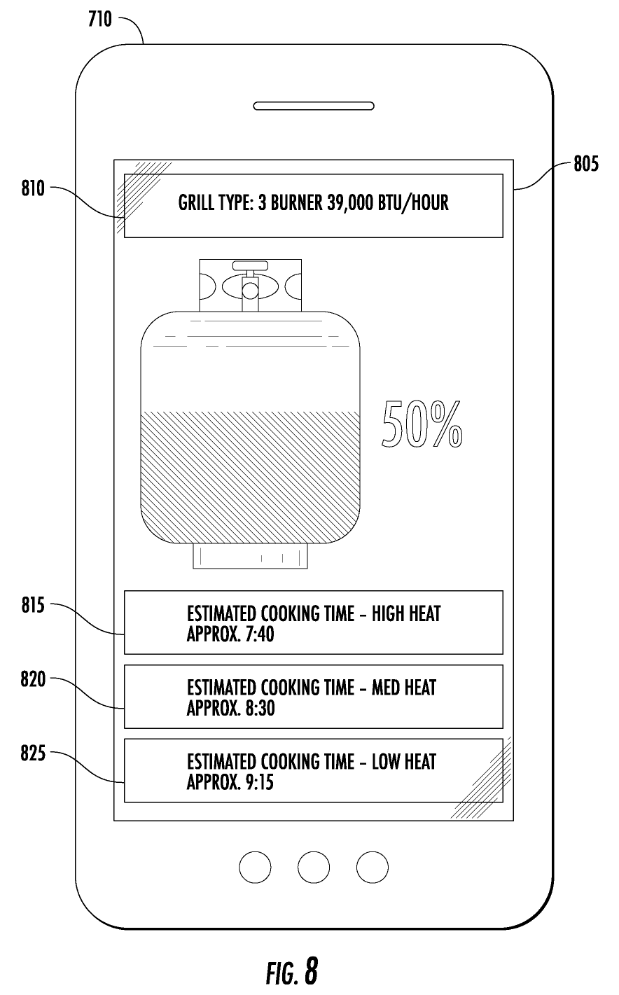

FIG. 7 shows an example of an environment where a wireless temperature probe may be used. The environment includes cooking appliance 100, user device 710, home network 720, and wearable device 730. Home network 720 may be connected to server 750 via network 740. Server 750 may include database 760.

As shown in FIG. 7, tank scale (not shown) may send (e.g., transmit) an indication of how much fuel is contained in a fuel tank associated with cooking appliance 100. In particular, a tank scale may send (e.g., transmit) an indication of the quantity of fuel contained in a fuel tank to user device 710, wearable device 730, and/or server 750 via home network 720 and/or network 740. In some instances, the amount of fuel determined by the tank scale may be sent to the devices indicated above via repeater 705. While a grill is shown in FIG. 7, it will be appreciated that any suitable cooking appliance, such as a smoker, an oven, etc., may be used in its place.

Repeater 705 may comprise a first interface to receive wireless communications from a tank scale. Repeater 705 may comprise a second interface to send wireless communications to user device 710, wearable device 730, and/or server 750. In some instances, the first interface and the second interface may be the same interface. In other examples, the first interface and the second interface are different interfaces. The first interface may be configured to receive electronic communications using a short-range wireless communication protocol, such as Bluetooth, Zigbee, Z-Wave, ANT, LoRa, or any equivalent thereof. The second interface may be configured to send electronic communications and/or signals using wireless communication protocols, such as IEEE 802.11, WiFi, GSM, CDMA, and the like.

User device 710 may be a mobile device, such as a cellular phone, a mobile phone, a smart phone, a tablet, a laptop, or the like. Alternatively, user device 710 may be any suitable internet-enabled device, such as a smart speaker, smart television, or the like. User device 710 may have one or more applications stored thereon. A first application, of the one or more applications, may be associated with cooking appliance 100. The first application may be configured to receive and display information associated with cooking appliance 100, including, for example, an amount of fuel contained in a fuel tank associated with cooking appliance 100. The first application may be configured to generate an alert, for example, when the amount of fuel contained in the fuel tank is below a threshold. The alert may be an audible alert, a visual alert, a tactile alert, or any combination thereof.

Wearable device 730 may be a device worn and/or attached to a user. In this regard, wearable device may be a smart watch, a fitness tracker, VR/AR goggles, etc. The wearable device 730 may have one or more applications or applets that are configured to receive and display the amount of fuel contained in a fuel tank associated with cooking appliance 100. The one or more applications may be configured to generate an alert, for example, when the amount of fuel contained in the fuel tank is below a threshold (e.g., < 20%). The alert may be an audible alert, a visual alert, a tactile alert, or any combination thereof.

Server 750 may be any server capable of executing application 752. As noted above, server 750 may be communicatively coupled to database 760. Server 750 may be a stand-alone server, a corporate server, or a server located in a server farm or cloud-computer environment. According to some examples, server 750 may be a virtual server hosted on hardware capable of supporting a plurality of virtual servers.

Application 752 may be server-based software configured to receive an amount of fuel contained in a fuel tank associated with cooking appliance 100. Additionally or alternatively, application 752 may be configured to receive an empty weight of the fuel tank associated with cooking appliance 100 and/or a full weight of the fuel tank associated with cooking appliance 100. Application 752 may store the empty weight and the full weight of the full tank, for example, in database 752. Application 752 may be configured to determine a volume of fuel contained in the fuel tank, for example, based on the fuel weight of the fuel tank, the empty weight of the fuel tank, and/or the current weight of the fuel tank. Application 752 may be further configured to send a notification of the current volume of the fuel tank to user device 710 and/or wearable device 730. The notification may be sent via one or more electronic communications, such as a text message, a push notification, etc. In some examples, the notification may comprise an indication of how much cooking time is left. The indication of how much cooking time is left may be determined by application 752, for example, based on the volume of fuel in the fuel tank, a model of cooking appliance 100, and/or various cooking temperatures.

Database 760 may be configured to store information on behalf of application 752. The information may include, but is not limited to, personal information and/or account information for a user. As noted above, database 760 may store the empty weight and the full weight of the full tank. Database 760 may also store a current weight of the full tank. Additionally or alternatively, database 760 may store a model of cooking appliance 100. Database 760 may include, but is not limited to, relational databases, hierarchical databases, distributed databases, in-memory databases, flat file databases, XML databases, NoSQL databases, graph databases, and/or a combination thereof.

Network 740 may include any type of network, including, for example, the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and cardholders to support input, extraction, and manipulation of data between the various computing devices. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls.

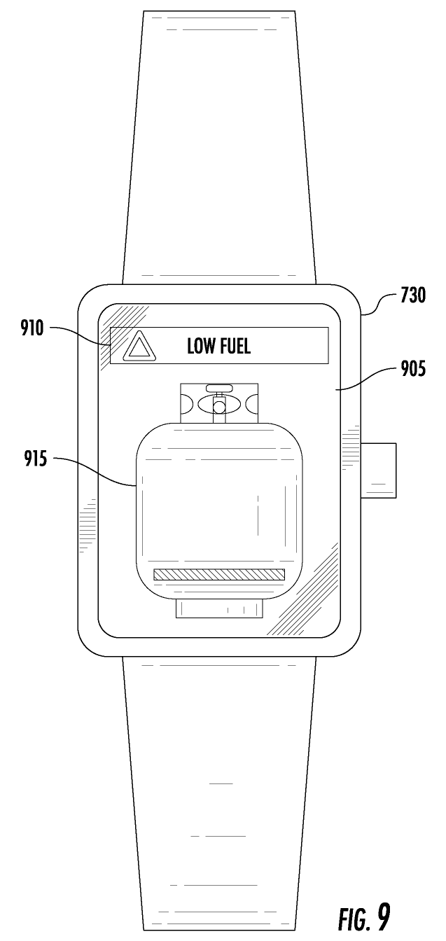

FIG. 8 shows an example of a user interface in accordance with one or more aspects of the disclosure. In particular, user device 710 may be configured to display interface 805. Interface 805 may be associated with a mobile application associated with cooking appliance 100. As shown in FIG. 8, interface 805 may display a volume of fuel contained in a fuel tank associated with cooking appliance 100. While FIG. 8 shows the volume at 50%, it will be appreciated that the volume may be updated at any time and, in some instances, in real-time. Interface 805 may also comprise a first field 810 configured to display a model of cooking appliance 100, a second field 815 indicating an amount of cooking time at high heat, a third field 820 indicating an amount of cooking time at medium heat, and a fourth field 825, indicating an amount of cooking time at a low heat. The displayed cooking times may be calculated, determined, and/or estimated based on a plurality of factors, including, for example, a volume of fuel contained in the fuel tank, the model of cooking appliance, a flow rate of the fuel, environmental factors (e.g., temperature, humidity, wind, etc.), and the like. By displaying the estimated cooking time, a user may be able to determine if he/she has enough fuel to complete his/her cook.

FIG. 9 shows an example an interface on wearable device 730 in accordance with one or more aspects of the disclosure. Wearable device 730 may comprise an interface 905, which may be associated with a mobile application executing on user device 710. Additionally or alternatively, interface 905 may be associated with a second mobile application executing on wearable device 730. The second mobile application may be configured to receive and/or display an amount of fuel contained in a fuel tank associated with cooking appliance 100. As shown in FIG. 9, interface 905 may comprise a first field 910 configured to display an alert. The alert may indicate low fuel in a fuel tank associated with a cooking appliance. The alert may be generated, for example, when a volume of the fuel is below a threshold amount (e.g., 20%). Additionally or alternatively, interface 905 may icon 915. Icon 915 may be configured to indicate a volume of fuel in a fuel tank associated with cooking appliance 100. The alerts and interface 905 may be a useful indication and/or reminder to replace and/or refill a fuel tank associated with cooking appliance 100.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) Python, Perl, or any equivalent thereof. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

1. A device comprising:
a housing comprising a support mechanism that extends outward from the housing, wherein the support mechanism is configured to receive a tank;
a sensor configured to measure a weight of the tank; and
a processor configured to determine a volume of a liquid contained in the tank based on the weight of the tank.

2. The device of claim 1, wherein the support mechanism comprises an arm.

3. The device of claim 1, further comprising:
a transceiver configured to transmit the volume of the liquid to a computing device.

4. The device of claim 1, further comprising:
a display configured to display the volume of the liquid.

5. The device of claim 4, further comprising:
an accelerometer, wherein the display is configured display the volume of the liquid in response to the accelerometer detecting a user input.

6. The device of claim 5, wherein the user input comprises tapping.

7. The device of claim 4, further comprising:
a second sensor, wherein the display is configured display the volume of the liquid in response to the second sensor detecting a predetermined amount of light.

8. The device of claim 7, wherein the second sensor comprises a photoreceptor.

9. The device of claim 4, further comprising:
a button, wherein the display is configured display the volume of the liquid in response to the button being pressed.

10. The device of claim 1, further comprising:
a display configured to indicate a battery level of a power supply.

11. The device of claim 1, wherein:
the sensor comprises a time-of-flight sensor; and
the weight of the tank is determined based on a distance the support mechanism has travelled from the time-of-flight sensor.

12. The device of claim 1, wherein the sensor comprises at least one of:
a load cell; or
a hall effect sensor.

13. The device of claim 1, wherein:.
the sensor comprises a potentiometer; and
the weight of the tank is determined based on a voltage measured by the potentiometer.

14. The device of claim 1, wherein the support mechanism comprises an I-beam.

15. A system comprising:
a cooking apparatus comprising a hanging tank scale, wherein the hanging tank scale comprises:
a support mechanism configured to receive a tank;
a sensor configured to measure a weight of the tank; and
a processor configured to determine a volume of a liquid contained in the tank based on the weight of the tank; and
a computing device configured to:
receive the volume of the liquid contained in the tank;
determine an amount of cooking time based on the volume of the liquid contained in the tank; and
cause the volume of the liquid contained in the tank and the amount of cooking time to be displayed.

16. The system of claim 15, wherein the computing device is further configured to determine the amount of cooking time based on a type of the cooking apparatus.

17. The system of claim 15, wherein the computing device comprises a mobile device.

18. The system of claim 15, wherein the hanging tank scale further comprises:
a transceiver configured to transmit the volume of the liquid to the computing device.

19. The system of claim 18, wherein the transceiver is configured to communicate using a short-range wireless communication protocol.

20. The system of claim 15, wherein the hanging tank scale further comprises:
a display configured to display the volume of the liquid.
